(19) United States
(12) Patent Application Publication
(10) Pub. No.: US 2011/0268906 A1
(43) Pub. Date: Nov. 3, 2011

(54) CO-EXTRUSION DIE, METHOD OF EXTRUDING WITH THE DIE, AND EXTRUDED ARTICLES MADE THEREFROM

(76) Inventors: Ronald W. Ausen, St. Paul, MN (US); James M. Jonza, Woodbury, MN (US); Gibson L. Batch, St. Paul, MN (US); Paul D. Graham, Woodbury, MN (US)

(21) Appl. No.: 13/142,526

(22) PCT Filed: Dec. 18, 2009
(86) PCT No.: PCT/US2009/068617

§ 371 Date: Jun. 28, 2011

Related U.S. Application Data
(60) Provisional application No. 61/141,775, filed on Dec. 31, 2008.

(51) Int. Cl. B32B 3/10; B29C 47/06; B29C 47/12

(52) U.S. Cl. 428/54; 425/131.1; 264/176.1

(57) ABSTRACT

A die (20) comprising two die cavities (38,40), with each supplying one polymeric material, a septum (26) separating the two die cavities (38,40), and a die opening (44) through which an extrudate is extruded. The septum (26) has a dispensing edge (36) and a plurality of extrusion channels. First extrusion channels connect one die cavity (38) and second extrusion channels connect the other die cavity (40) to the dispensing edge (36). The first and second extrusion channels are disposed in alternating positions along the dispensing edge such that one first channel is disposed between any two adjacent second channels. A method of extruding with such a die (20) and an extruded article made therefrom. The extruded article comprises a plurality of longitudinal first zones composed of a first polymeric material alternating with a plurality of longitudinal second zones composed of a second polymeric material such that one first zone is disposed between any two adjacent second zones. The zones are generally parallel to one another.

The present invention relates to the art of extruding polymeric materials, in particular, to co-extruding two polymeric materials into an article, and more particularly, to co-extruding two polymeric materials into an extruded article comprising a plurality of longitudinal first zones composed of one polymeric material alternating with a plurality of longitudinal second zones composed of another polymeric material such that one first zone is disposed between any two adjacent second zones. The present invention also relates to an extrusion die useful for make such an extruded article and a method of extruding with such a die.

### BACKGROUND

Co-extrusion of multiple polymeric components into a single layer film is known in the art. For example, multiple polymeric flow streams have been combined in a die or feedblock in a layered fashion to provide a top to bottom multilayer film. It is also known to provide more complicated coextruded film structures where the film is partitioned, not as coextensive layers in the thickness direction, but as stripes along the width dimension of the film. This has sometimes been called “side-by-side” coextrusion.

Even though extrusion devices are known for producing extruded products with side-by-side oriented extruded stripes, there is still a need for alternatives and improvements to such devices. The present invention provides such an alternative and improved device.

### SUMMARY OF THE INVENTION

In one aspect of the present invention, a die is provided for co-extruding a first extrudable polymeric material and a second extrudable polymeric material. The die comprises a first die cavity, a second die cavity, a septum separating at least a portion, most or all of the first die cavity and the second die cavity, and a die opening (e.g., in the form of a slot or any other desired shape) through which an extrudate comprising the first and second extrudable polymeric materials is extruded. The septum has a first side defining a portion of the first die cavity, a second side defining a portion of the second die cavity, a dispensing edge, a plurality of first extrusion channels, and a plurality of second extrusion channels. The septum can be, for example, an integral or separate shim, membrane or other dividing partition disposed so as to separate the first and second die cavities. The first extrusion channels connect the first die cavity to the dispensing edge, and the second extrusion channels connect the second die cavity to the dispensing edge. The first extrusion channels and the second extrusion channels are disposed in alternating positions along the dispensing edge such that one first channel is disposed between any two adjacent second channels (i.e., second channels that only have one first channel between them), and one second channel is disposed between any two adjacent first channels. Each of the channels can be, for example, in the form of a groove, tunnel or other pathway cut or otherwise formed in the septum. Each channel can have opposite side walls, a joining surface that connects the side walls together, an entrance opening on the corresponding side of the septum and an exit opening on the dispensing edge of the septum. A number of optional features can be employed in practicing the present inventive extrusion die, including the following.

The profiles of the first and second channels can be similar or different. For example, the opposite side walls of each channel can be parallel to each other or at an angle (e.g., an acute, right or obtuse angle) to each other. In addition, the side walls of the first channels can be formed perpendicular or slanted at an angle (other than a right angle) to the first side of the septum, or the side walls of the first channels can be formed so as to taper out from their joining surface to the first side and the dispensing edge of the septum (i.e., the distance between the side walls adjacent the joining surface can be smaller than the distance between the side walls either adjacent the first side of the septum, adjacent the dispensing edge, or both). Likewise, the side walls of the second channels can be formed perpendicular or slanted at an angle (other than a right angle) to the second side of the septum, or the side walls of the second channels can be formed so as to taper out from their joining surface to the second side and the dispensing edge of the septum (i.e., the distance between the side walls adjacent the joining surface can be smaller than the distance between the side walls either adjacent the second side of the septum, adjacent the dispensing edge, or both. The side walls of both sets of channels can be perpendicular to or tapered out to their corresponding side of the septum and the dispensing edge, or one set of channels can be perpendicular and the other set tapered. The depths of the first and second channels can also be similar or different. The use of slanted die channels will create slanted zones, relative to the plane of the extrudate (e.g., a film). Such a zone configuration could be useful, for example, for some light control applications.

Depending on the desired configuration of the resulting extrudate, it can be desirable for the exit openings of the first channels to extend from the first side of the septum toward but not all the way to the second side of the septum, for the exit openings of the second channels to extend from the second side of the septum toward but not all the way to the first side of the septum, or both. In this way, the degree to which the exit openings of the first and second channels overlap each other can be varied (e.g., the first and second exit openings can have no overlap, can have some overlap or completely overlap), as desired. Alternatively, the exit openings of the first channels can extend from the first side to the second side of the septum (i.e., across the entire thickness of the septum), the exit openings of the second channels can extend from the second side to the first side of the septum (i.e., across the entire thickness of the septum), or both. A combination can also be used. The present invention allows for the use of relatively narrow exit openings. For example, each exit opening of either the first or second channels can have a maximum width dimension (i.e., the maximum distance between opposite side walls of the channel at the exit opening) of less than or equal to about 1.5 mm (1500 micrometers). Though, larger channel width dimensions can be used in accordance with the present invention. The resistance to flowing a polymeric material through a channel can increase as the reciprocal of the third power of the channel width. This resistance can limit, as a practical matter, the effective minimum dimensions of the channels. As a result, each of the channels may have a minimum width dimension (i.e., the minimum distance between opposite side walls of the channel at the exit opening) of about 50 micrometers, or possibly as low as about 25 micrometers. It may be possible to extrude with even smaller channel width dimensions by using heat or radiation curable polymeric materials, since such materials typically have relatively lower viscosities than thermoplastic extrudable polymeric materials.

It is desirable for the joining surface of each of the channels to slope at an angle, preferably an acute angle, toward the dispensing edge. It is also desirable for the dispensing edge to be recessed back from the die opening within the die. When the dispensing edge is so recessed back, the die can include an optional recessed cavity between the dispensing edge and the die opening. The walls of such a recessed cavity can be straight (i.e., the die opening can be dimensionally comparable in height to the dispensing edge) or tapered toward the die opening (i.e., the die opening can be smaller in height than the dispensing edge). It can also be desirable to have the recessed cavity taper in width, after the flowstreams combine. Such an approach may be useful in producing finer width zones or stripes. The septum may have a rectangular shape, or it could be otherwise shaped such as, e.g., wedge-shaped to provide the septum with more stiffness in the region directly behind the dispensing edge.

In accordance with another aspect of the present invention, a method of producing an extruded article is provided. The method comprises providing a co-extrusion die according to the present invention, supplying a first extrudable polymeric material into the first cavity, supplying a second extrudable polymeric material into the second cavity, extruding the first polymeric material through the plurality of first channels and the second polymeric material through the plurality of second channels so as to form a flow stream having a width with alternating zones (e.g., stripes of various cross sections) of the first and second polymeric materials, and extruding the flow stream through the die opening of the die so as to form an extrudate. A number of optional features can be employed in practicing the present inventive method, including the following.

The mass flow of the first and the second polymeric materials, as they are respectively extruded through the first and second channels, can be equal or unequal. The die may dispense the extrudate into free space, or the extrudate may be taken up onto a roller, web or substrate. Once the extruded article has been formed, various secondary operations may then be performed on the article. Such secondary operation may include but are not limited to embossing, laminating, slitting, knurling, length and/or width orientation, and the like. For example, the extrudate can comprise opposite major surfaces, and the method can further comprise microreplicating or otherwise replicating a pattern in one or both of the major surfaces of the extrudate. The replicating can comprise contacting one or both of the major surfaces of the extrudate with a patterned roll, patterned belt, patterned film, or a combination thereof. The method can also comprise quenching or heating the extrudate respectively on a chilled or heated surface of, for example, a roller, web, flat or curved plate, or substrate.

The extrudate produced according to the present method can comprise a plurality of longitudinal first zones composed of the first polymeric material alternating with a plurality of longitudinal second zones composed of the second polymeric material. One first zone is disposed between any two adjacent second zones, and one second zone is disposed between any two adjacent first zones. The first zones can be separate from each other or integrally joined together, e.g., by a continuous layer. In addition, the second zones can be separate from each other or integrally joined together, e.g., by a continuous layer. In addition, one of the zones can each be separate from one another and the other zones can be integrally joined together. Preferably, the first zones are generally parallel to one another, the second zones are generally parallel to one another, and the first and second zones are generally parallel to each other. Each of the zones can be in the form of a stripe having a number of different cross sectional shapes. Such an extrudate can comprise a plurality of longitudinal first stripes composed of the first polymeric material alternating with a plurality of longitudinal second stripes composed of the second polymeric material.

In accordance with an additional aspect of the present invention, an extruded article is provided that comprises a plurality of longitudinal first zones composed of a first polymeric material alternating with a plurality of longitudinal second zones composed of a second polymeric material such that one first zone is disposed between any two adjacent second zones and one second zone is disposed between any two adjacent first zones. The zones are generally parallel to one another. In addition, the present invention enables the formation of relatively narrow zones. For example, the maximum width dimension of at least one of each first zone and each second zone can be less than or equal to about 1.5 mm (1500 micrometers). At least one of each first zone and each second zone may have a minimum width dimension that is about 50 micrometers, or possibly as low as about 25 micrometers. A number of optional features can be employed in practicing the present inventive extruded article, including the following.

The first and second polymeric materials may be similar or very different in composition. Depending on the intended end use, the two polymeric materials may adhere to each other with a strong cohesive or adhesive bond, or be readily separable from each other (i.e., the bond between the first and second zones may be relatively easy to break). The present extruded article can have each of the first zones be separate from one another and the second zones be integrally joined together, for example, by a continuous layer. Alternatively, the first zones can be integrally joined together (e.g., by a continuous layer) and the second zones can be integrally joined together (e.g., by a continuous layer). In another embodiment, each of the first zones can be separate from one another and each of the second zones can be separate from one another. Each zone can be in the form of a stripe or strand having a number of different cross sectional shapes. The extruded article can also have opposite major surfaces, with at least one of the major surfaces bearing a microreplicated or otherwise replicated pattern.

When the intention is to make an extruded article with one or both of the zones having an adhering nature, any chemistry which permits them to do so is considered within the scope of the invention. For example, one of the polymeric materials could be a pressure sensitive adhesive. The types of bonds formed as a result of the first polymeric material (i.e., the first zones) contacting and reacting with the second polymeric material (i.e., the second zones) can include but are not limited to dipole/dipole interactions, acid-base bonding, hydrogen bonding, and covalent bonding.

The above summary of the present invention is not intended to describe each disclosed embodiment or every implementation of the present invention. The description that follows more particularly exemplifies illustrative embodiments. It is to be understood, therefore, that the drawings and following description are for illustration purposes only and should not be read in a manner that would unduly limit the scope of this invention.

### BRIEF DESCRIPTION OF THE DRAWINGS

In the accompanying drawings:

FIG. 1 is a perspective view of an extrusion die 20 in accordance with one embodiment of the present invention;

FIG. 2 is a cross-sectional side view of the extrusion die of FIG. 1, taken along section lines 2-2 in FIG. 1;

FIG. 3 is a top view of a shim from the extrusion die of FIG. 1, shown in isolation;

FIG. 4 is a detailed perspective view of the area marked “A” in FIG. 3;

FIG. 5 is a detailed cross-sectional perspective view of region “B” in FIG. 2, tilted at a slight perspective angle for better clarity;

FIGS. 6a to 6e are each a front detail view, looking straight into the die slot, of various alternative embodiments of a shim having a particular arrangement of grooves where they exit at the dispensing edge;

FIG. 7a is a micrograph of a cross-section of the extruded film produced in Example 1;

FIG. 7b is a micrograph of a cross-section of the extruded film produced in Example 2;

FIG. 7c is a micrograph of a cross-section of the extruded film produced in Example 3; and

FIG. 7d is a micrograph of a cross-section of the extruded film produced in Example 4.

### DETAILED DESCRIPTION OF THE PREFERRED EMBODIMENTS

In describing preferred embodiments of the invention, specific terminology is used for the sake of clarity. The invention, however, is not intended to be limited to the specific terms so selected, and each term so selected includes all technical equivalents that operate similarly.

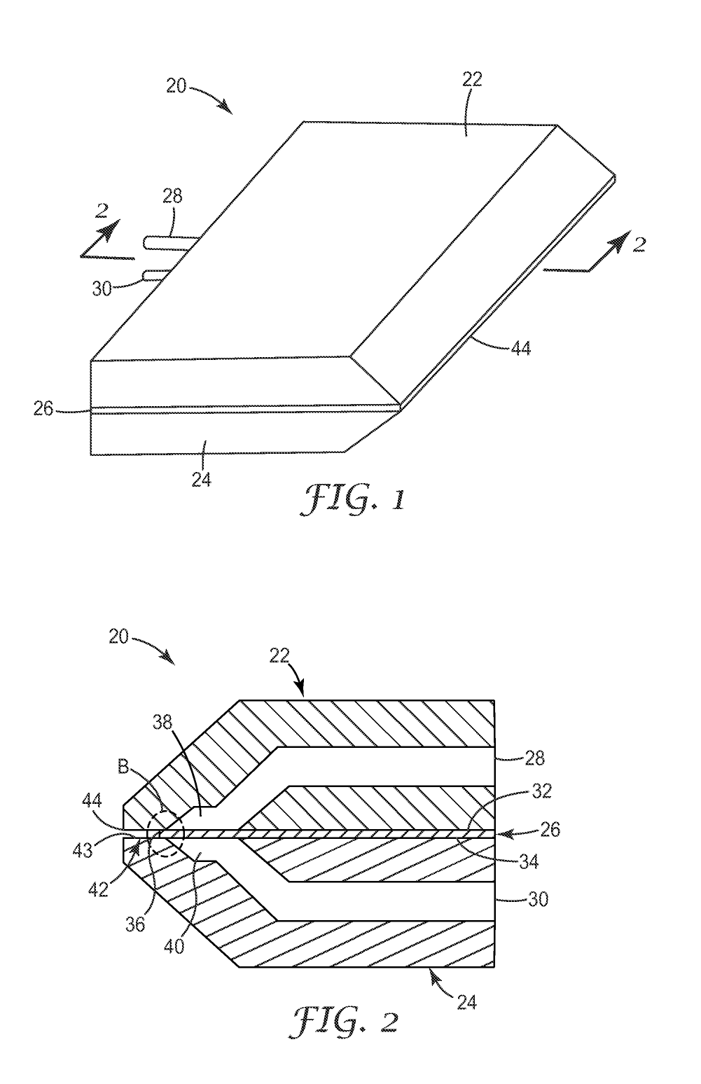

Referring now to FIG. 1, one embodiment of an extrusion die 20 in accordance with the present invention includes a first die portion 22 and a second die portion 24. A septum in the form of a metal shim 26 is disposed between the first and the second die portions 22 and 24. The first die portion 22 has a first inlet 28 for receiving a supply of a first extrudable polymeric material, and the second die portion 24 has a second inlet 30 for receiving a supply of a second extrudable polymeric material. In typical operation, the first material inlet 28 and the second material inlet 30 are connected to respective sources of extrudable polymeric materials such as, for example, melt pipes or heated hoses of conventional type connected to pumps or screw extruders.

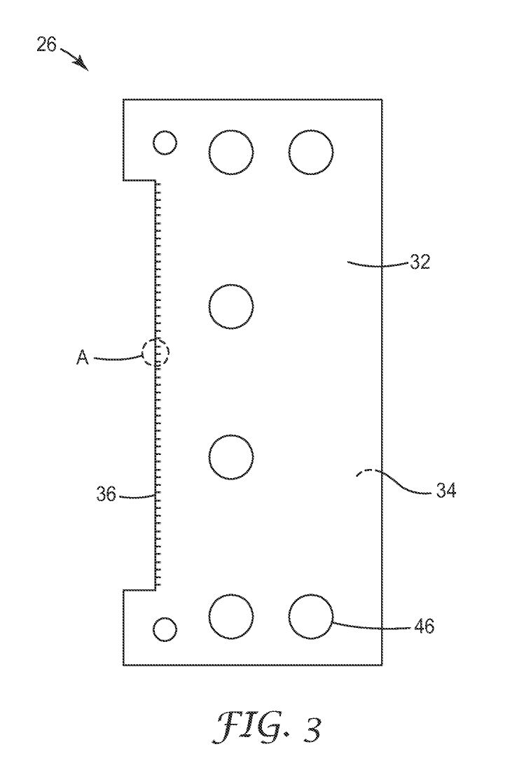

Referring now to FIG. 2, the shim 26 has a first side 32 and a second side 34 and a leading dispensing edge 36. The first side 32 of the shim 26 and the first die portion 22 together define a first die cavity 38, and the second side 34 of the shim 26 and the second die portion 24 together define a second die cavity 40. In the depicted convenient embodiment, the die portions 22 and 24 together define a recessed cavity 42 formed in front of the dispensing edge 36 and recessed back inside the die 20 from a die opening or slot 44 through which the polymeric materials are extruded. The recessed cavity 42 includes a land 43. During use of the die 20, the cavities 38 and 40 on either side of the shim 26 will be filled with pressurized extrudable polymeric material. Therefore, care should be taken so that the pressure differential between these cavities 38 and 40 does not exceed the physical distortion strength of the shim 26. For adequate strength, at thickness between about 1 and 2 mm has provided acceptable results, with a thickness of 60 mils (1.5 mm) being considered appropriate for many applications. Manipulation of the viscosity of one or both of the two polymeric materials may be helpful in keeping the pressure differential within acceptable limits.

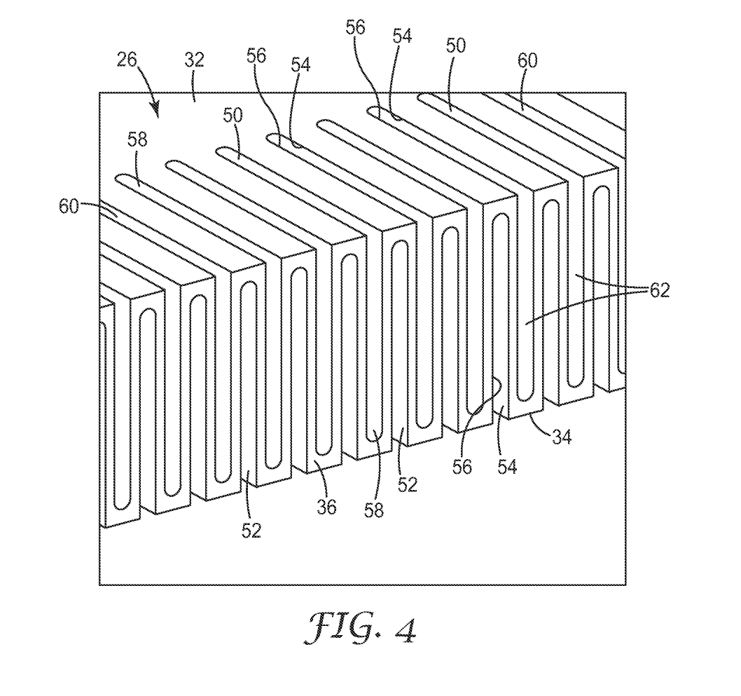

Referring to FIG. 3, the shim 26 from the extrusion die 20 is designed so that the dispensing edge 36 is recessed back from the die slot 44 and the cavity 42 can be formed, as shown in FIG. 2. Recessing the dispensing edge 36 is convenient in many embodiments, but it is not considered a requirement of the present invention. Several through holes 46 can be formed through the shim 26 for receiving therethrough a mechanism, e.g. machine bolts, for holding the various components of the extrusion die 20 together as an assembly.

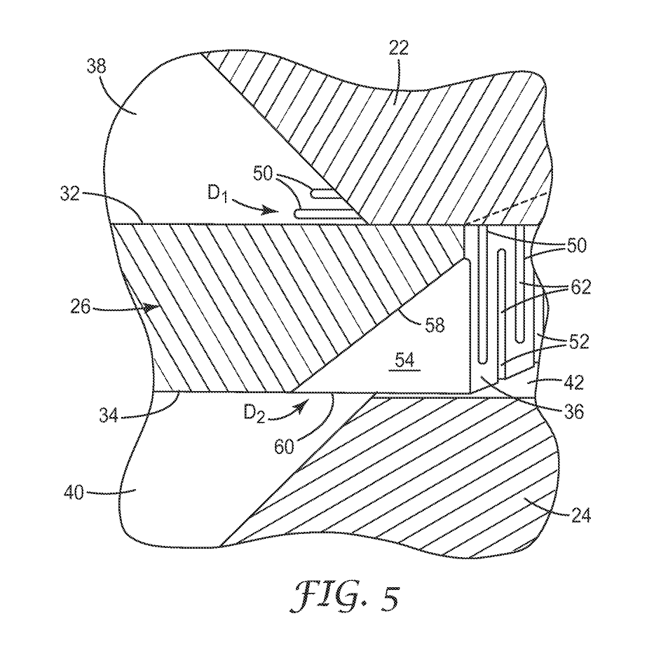

In the following illustrative embodiments, the first and second extrusion channels are in the form of grooves cut into the dispensing edge 36 of the shim 26. Referring to FIG. 4, a first plurality of grooves 50 have been cut into the first side 32 of shim 26 such that in the assembled die 20 the grooves 50 extend from the first cavity 38 to the dispensing edge 36. Further, a second plurality of grooves 52 have been cut into the second side 34 of shim 26 such that in the assembled die 20 the grooves 52 extend from the second cavity 40 to the dispensing edge 36. Each of the grooves 50 and 52 comprises opposite side walls 54 and 56, a joining surface 58 that connects the side walls 54 and 56 together (i.e., a bottom floor in the case of the first grooves 50 and a top ceiling in the case of the second grooves 52), an entrance opening 60 on the corresponding side of the shim 26 and an exit opening 62 on the dispensing edge 36 of the shim 26. The first plurality of grooves 50 is interleaved with the second plurality of grooves 52. As illustrated, the grooves 50 and 52 are disposed in alternating positions along the dispensing edge 36 such that one first channel 50 is disposed between any two adjacent second channels 52, and one second channel 52 is disposed between any two adjacent first channels 50.

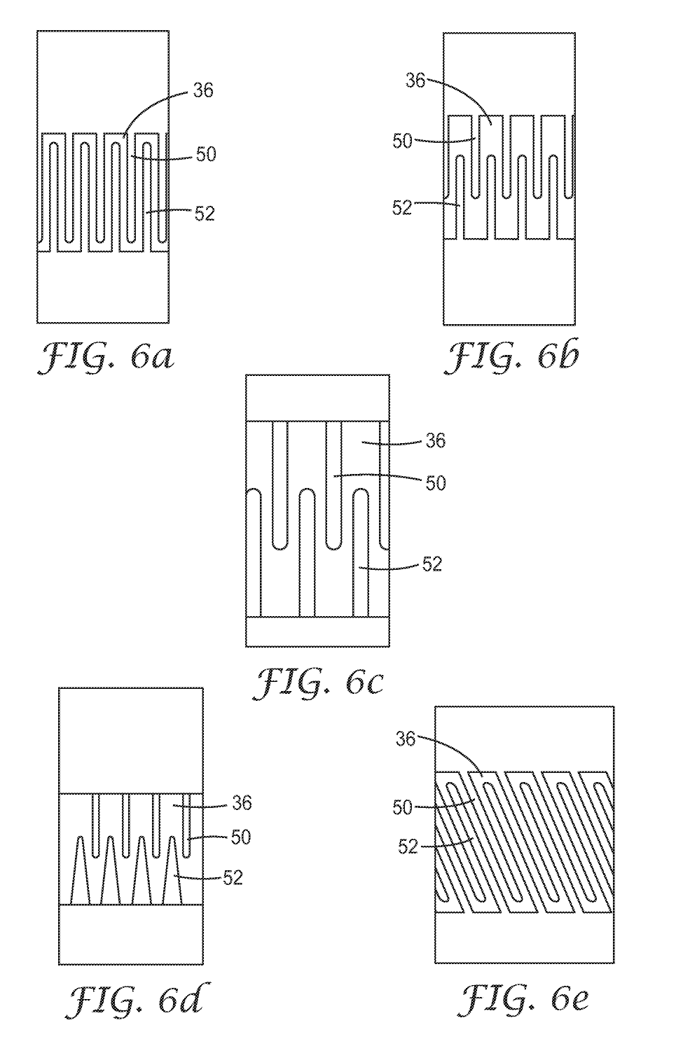

Referring to FIG. 5, the shim 26 is compressed so as to form a tight seal in a region adjacent to the dispensing edge 36 between both first die portion 22 and second die portion 24. These seals keep the flowing polymeric material in cavities 38 and 40 entirely separate until they are dispensed from the dispensing edge 36. The distance along shim 26 where the first and second die portions 22 and 24 seal against shim 26 needs to be long enough to provide a robust seal and structural strength. A sealing distance of about 1.0 mm is considered appropriate for many useful applications. The first polymeric material in the first cavity 38 can only reach dispensing edge 36 by entering the openings 60 of first grooves 50 in direction D1, and the second polymeric material in the second cavity 40 can only reach dispensing edge 36 by entering the openings 60 of first grooves 52 in direction D2.

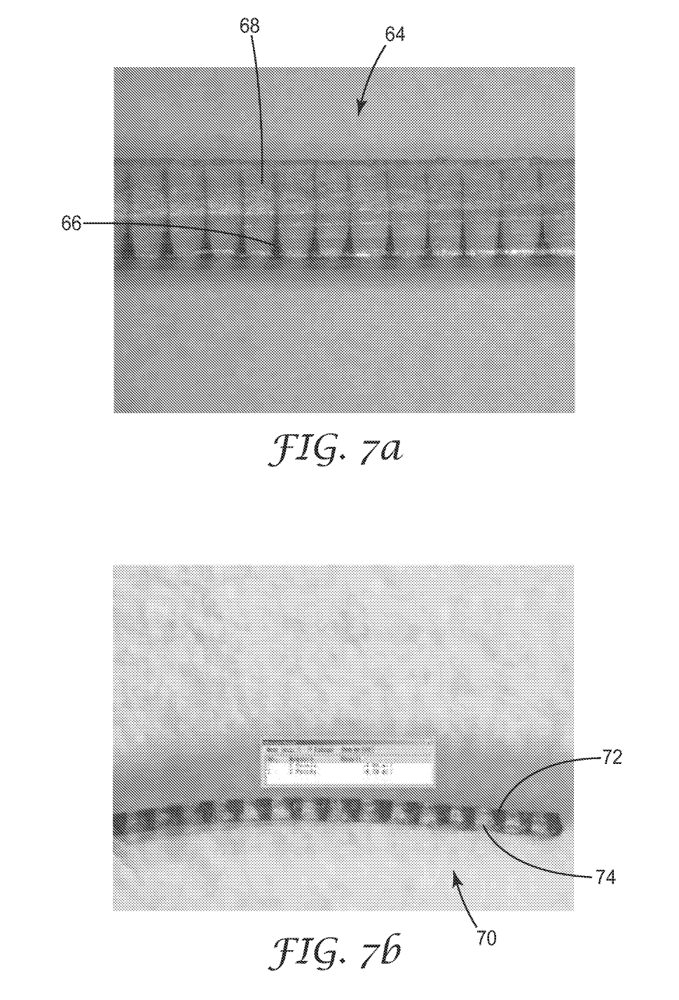

Referring to FIG. 6a, in a first embodiment of the shim 26, useful for general side-by-side coextrusion purposes, both the first grooves 50 and the second grooves 52 have side walls that are perpendicular to the corresponding side of the shim 26 from which they are cut. The first grooves 50 and the second grooves 52 are both cut deeply into the shim 26 so that there is a substantial zone of overlap. Referring to FIG. 6b, in an alternate embodiment of the shim 26, both the first grooves 50 and the second grooves 52 have side walls that are perpendicular to the corresponding side of the shim 26 from which they are cut. However, the first grooves 50 and the second grooves 52 are both cut less deeply into the shim 26, than in the FIG. 6a embodiment, so that there is a smaller amount of overlap between them. Referring to FIG. 6c, in another embodiment of the shim 26, both the first grooves 50 and the second grooves 52 have side walls that are perpendicular to the corresponding side of the shim 26 from which they are cut. However, the first grooves 50 and the second grooves 52 have unequal widths (i.e., their corresponding side walls are not spaced apart the same distance), which may sometimes be advantageous to achieve the desired widths of the zones (e.g., stripes) in the final product. Referring to FIG. 6d, in an additional embodiment of the shim 26, the first grooves 50 have side walls that are perpendicular to the corresponding side of the shim 26 from which they are cut and the second grooves 52 have been cut so as to form side walls that taper at a non-right angle to the corresponding side of the shim 26. In this way, the second grooves 52 can be seen as being wedge-shaped. Referring to FIG. 6e, in yet another embodiment of the shim 26, both the first grooves 50 and the second grooves 52 have side walls that are slanted at the same acute angle from perpendicular to the corresponding side of the shim 26 from which they are cut. The first grooves 50 and the second grooves 52 are both cut deeply into the shim 26 so that there is a substantial zone of overlap. The use of slanted grooves 50 and 52 will create slanted zones or stripes of the polymeric materials, relative to the plane of the extrudate (e.g., a film). Such a zone configuration could be useful, for example, for some light control applications.

In each of the above embodiments of shim 26, illustrated in FIGS. 6a to 6e, a continuous foil of shim material separates the two polymeric materials being extruded until they reach the dispensing edge 36. These embodiments also illustrate that the degree to which the exit openings 62 of the first and second grooves 50 and 52 overlap each other can be varied (e.g., the first and second exit openings can have no overlap, can have some overlap or completely overlap), as desired. Other shapes besides perpendicular, slanted and tapered may be used when convenient in connection with the present invention. A preferred method of cutting the grooves 50 and 52 in the shim 26 is wire electrical discharge machining (EDM). Other methods of machining could include e.g., laser, e-beam, or diamond machining. The present invention is not intended to be limited to the type of forming technique or equipment used to make the grooves 50 and 52.

The present invention is also not intended to be limited to the use of any particular polymeric materials in accordance with the present invention. Thus, any polymeric material that can be made to flow through the grooves 50 and 52, or any other extrusion channels, may be used. In addition to conventional extrudable thermoplastic polymeric materials, the present invention may also be used to co-extrude polymeric materials that can be crosslinked. For example, either or both of the first and second extrudable polymeric materials may be a heat or radiation curable resin. When a heat curable resin is used, the die 20 can be heated to start the cure so as to adjust the viscosity of the polymeric material and/or the pressure in the corresponding die cavity 38 and 40. Since the viscosity of heat and radiation curable polymeric materials can be 100 to 10,000 times lower than that of melt extruded thermoplastic polymeric materials, the use of such curable polymeric materials may allow even smaller zones or stripes to be formed.

Several examples were prepared to demonstrate the apparatus and method for making the microstriped film. For each of them, a coextrusion die was assembled generally as depicted in FIG. 1. The first die portion 22 and a second die portion 24 were fabricated from 15-5 stainless steel generally as depicted in FIG. 2. A shim 26 was prepared from 1 mm thick precision ground stainless steel sheet material, generally as depicted in FIG. 3. The shim 26 was machined along the dispensing edge 36 to provide a first and a second plurality of grooves 50 and 52, generally as depicted in FIG. 6a. This machining was done by wire electron discharge machining (EDM). The grooves were 0.0625 mm in width and cut into the corner of the dispensing edge 36 of the shim 26. The grooves were 1.6 mm in length (from the dispensing edge 36 back towards the die cavities) and 0.875 mm in height (in the direction of the thickness of the dispensing edge). The grooves were prepared with a repeat across the dispensing edge in an alternating pattern at a spacing of 0.1125 mm per groove. The full width of extrusion slot 44 was 125 mm.

### Exemplary Embodiments

1. A die for co-extruding a first extrudable polymeric material and a second extrudable polymeric material, the die comprising:

a first die cavity;

a second die cavity;

a septum separating at least a portion of said first die cavity and said second die cavity, said septum having a first side defining a portion of said first die cavity, a second side defining a portion of said second die cavity, a dispensing edge, and a plurality of first extrusion channels and a plurality of second extrusion channels, with said plurality of first extrusion channels connecting said first die cavity to said dispensing edge, said plurality of second extrusion channels connecting said second die cavity to said dispensing edge, and said plurality of first extrusion channels and said plurality of second extrusion channels being disposed in alternating positions along said dispensing edge such that one first channel is disposed between any two adjacent second channels; and

a die opening through which an extrudate comprising the first and second extrudable polymeric materials is extruded.

2. The die according to embodiment 1, wherein each of said channels has an exit opening on said dispensing edge, and each said exit opening has a maximum width dimension of less than or equal to about 1.5 mm.
3. The die according to embodiment 2, wherein each said exit opening has a minimum width dimension of about 50 micrometers.
4. The die according to any one of embodiments 1 to 3, wherein each said channel is at least partially defined by opposite side walls with the side walls of at least said first channels being perpendicular or slanted at an angle to the first side of said septum.
5. The die according to any one of embodiments 1 to 3, wherein each said channel is at least partially defined by opposite side walls and a joining surface, with the side walls of at least said first channels tapering out from their joining surface to the first side and the dispensing edge of said septum.
6. The die according to any one of embodiments 1 to 5, wherein said dispensing edge is recessed back from said die opening within said die.
7. The die according to any one of embodiments 1 to 6, wherein each said channel is at least partially defined by opposite side walls and a joining surface, and the joining surface of each said channel slopes at an angle toward said dispensing edge.
8. The die according to any one of embodiments 1 to 7, wherein each said channel has an exit opening on said dispensing edge, and the exit openings of at least said first channels extend from the first side of said septum toward but not all the way to the second side of said septum.
9. The die according to embodiment 8, wherein the exit openings of said second channels extend from the second side of said septum toward but not all the way to the first side of said septum.
10. The die according to any one of embodiments 1 to 7, wherein each said channel has an exit opening on said dispensing edge, and the exit openings of at least said first channels extend from the first side to the second side of said septum.
11. A method of producing an extruded article, the method comprising:

providing a co-extrusion die according to any one of embodiments 1 to 9;

supplying a first extrudable polymeric material into the first cavity;

supplying a second extrudable polymeric material into the second cavity; extruding the first polymeric material through the plurality of first channels and the second polymeric material through the plurality of second channels so as to form a flow stream having a width with alternating zones of the first and second polymeric materials; and

extruding the flow stream through the die opening of the die so as to form an extrudate comprising a plurality of longitudinal first zones composed of the first polymeric material alternating with a plurality of longitudinal second zones composed of the second polymeric material such that one first zone is disposed between any two adjacent second zones.

12. The method according to embodiment 11, wherein at least one of the first zones and the second zones are integrally joined together.
13. The method according to embodiment 11 or 12, wherein each zone is in the form of a stripe, such that the extrudate comprises a plurality of longitudinal first stripes composed of the first polymeric material alternating with a plurality of longitudinal second stripes composed of the second polymeric material, with one first stripe being disposed between any two adjacent second stripes, the first stripes being generally parallel to one another, the second stripes being generally parallel to one another, and the first and second stripes being generally parallel to each other.
14. The method according to any one of embodiments 11 to 13, wherein the mass flow of the first and the second polymeric materials, as they are respectively extruded through the first and second channels, are equal or unequal.
15. The method according to any one of embodiments 11 to 14, wherein the extrudate comprises opposite major surfaces, and said method further comprises replicating a pattern in at least one of the major surfaces.
16. The method according to embodiment 15, wherein said replicating comprises contacting one or both of the major surfaces of the extrudate with a patterned roll, patterned belt, patterned film, or a combination thereof.
17. The method according to any one of embodiments 11 to 16, further comprising quenching the extrudate on a chilled surface.
18. An extruded article comprising a plurality of longitudinal first zones composed of a first polymeric material alternating with a plurality of longitudinal second zones composed of a second polymeric material such that one first zone is disposed between any two adjacent second zones, wherein the zones are generally parallel to one another, and at least one of each first zone and each second zone has a maximum width dimension of less than or equal to about 1.5 mm.
19. The extruded article according to embodiment 18, wherein the minimum width dimension of at least one of each first zone and each second zone is about 50 micrometers.
20. The extruded article according to embodiment 18 or 19, wherein each of the first zones is separate from one another, and the second zones are integrally joined together.
21. The extruded article according to embodiment 18 or 19, wherein the first zones are integrally joined together and the second zones are integrally joined together.
22. The extruded article according to embodiment 18 or 19, wherein each of the first zones is separate from one another and each of the second zones is separate from one another.
23. The extruded article according to any one of embodiments 18 to 22, wherein each zone is in the form of a stripe.
24. The extruded article according to any one of embodiments 18 to 23, wherein said extruded article comprises opposite major surfaces, and at least one of the major surfaces bears a replicated pattern.

In each of the Examples below, the first material inlet (introducing Polymer A from Table 1 below into the extrusion die) was fed with a melt train focused around a 32 mm single screw extruder. The second material inlet (introducing Polymer B from Table 1 below into the extrusion die) was fed with a melt train focused around a 20 mm single screw extruder. During the co-extrusion runs, the die was positioned adjacent to a chilled roller so that the coextruded film was quenched while being taken away on the chilled roller. Down web, the coextruded film was wound up into a roll. Temperatures and extrusion conditions were as shown in Table 1.

TABLE 1

| | Example 1 | | Example 2 | | Example 3 | | Example 4 | |
|---|---|---|---|---|---|---|---|---|
| Polymer A | 3155 PP | | 40W EVA | | 95/5 Adhesive | | 95/5 Adhesive | |
| Polymer B | 3155 PP w | | 40W EVA w | | 40W EVA w | | 40W EVA w | |
| | 2% Black | | 2% Black | | 2% Black | | 2% Black | |
| Polymer A | 3.0 | | 1.5 | | 1.5 | | 2.0 | |
| kg/hr | | | | | | | | |
| Polymer B | 0.75 | | 1.5 | | 1.5 | | 1.0 | |
| kg/hr | | | | | | | | |
| Polymer A | 150° | C. | 93° | C. | 93° | C. | 93° | C. |
| Extruder | | | | | | | | |
| Barrel 1 Temp | | | | | | | | |
| Polymer A | 210° | C. | 210° | C. | 210° | C. | 210° | C. |
| Remaining | | | | | | | | |
| Barrel Temps | | | | | | | | |
| Polymer B | 193° | C. | 65° | C. | 65° | C. | 65° | C. |
| Extruder | | | | | | | | |
| Barrel 1 Temp | | | | | | | | |
| Polymer B | 210° | C. | 210° | C. | 210° | C. | 210° | C. |
| Remaining | | | | | | | | |
| Barrel Temp | | | | | | | | |
| Takeaway | 0.9 | m/min | 3 | m/min | 3 | m/min | 3 | m/min |
| Speed | | | | | | | | |
| Die Temp | 216° | C. | 216° | C. | 216° | C. | 216° | C. |

Material notes:
3155PP is a 35 melt flow index polypropylene available from ExxonMobil ™.
40W EVA is Elvax ™ ethylene vinyl acetate available from DuPont ™, 40% by weight vinyl acetate. Melt index 52 g/10 min.
95/5 is an acrylate adhesive, 95% ethyl hexyl acrylate, 5% acrylic acid.
Condition notes:
The 95/5 adhesive was pumped into the extruder using a “Bonnot” brand adhesive pump using a heated hose. The pump had an extruder screw with a gear pump. The temperatures were set at 175° C. for the pump and hose. The rate was set using the gear pump speed. The adhesive was injected into the extruder at the barrel 1 injection port.

### Example 1

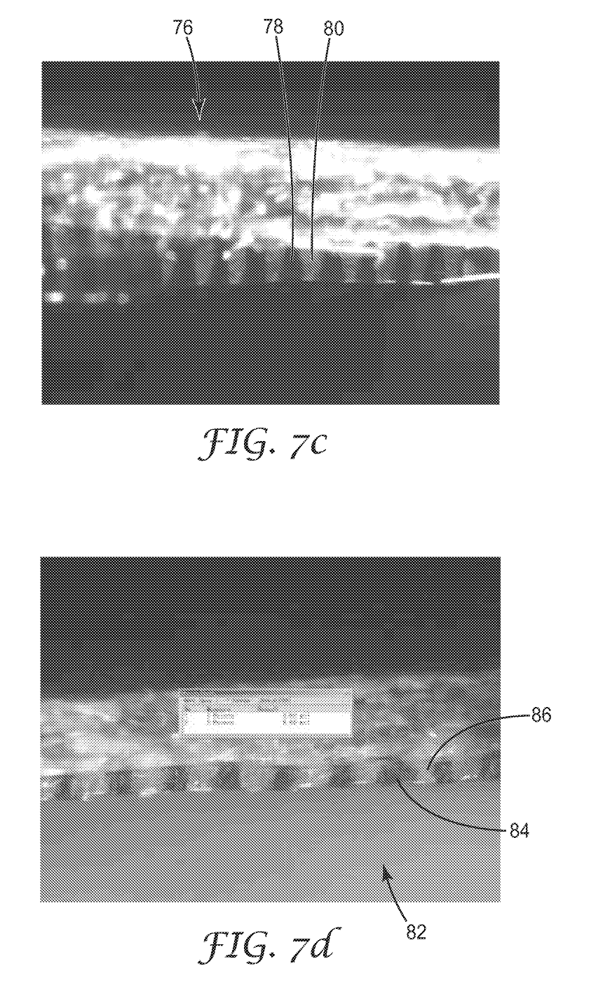

In this example, both Polymer A and Polymer B are polypropylene, distinct only in that Polymer B included a black pigment. Polymer A was introduced into the coextrusion die at a mass flow rate four times greater than Polymer B. This resulted in a striped film 64 having very thin longitudinal stripes 66 of black polypropylene alternating with wider stripes 68 of clear polypropylene. The resulting film 64 could be used, e.g. for a privacy film for optical display screens. FIG. 7a is a micrograph of a cross-section of the film 64 produced in Example 1.

### Example 2

In this example, both Polymer A and Polymer B are ethylene vinyl acetate polymers, delivered to the die in a 1:1 mass flow ratio, with Polymer B being a black pigmented EVA. This resulted in a striped film 70 having stripes 72 of black pigmented EVA and stripes 74 of clear EVA that are relatively uniform in size. FIG. 7b is a micrograph of a cross-section of the film 70 produced in Example 2.

### Example 3

In this example, Polymer A is a 95/5 pressure sensitive adhesive, and Polymer B is a black pigmented EVA, delivered to the die in a 1:1 mass flow ratio. This resulted in a striped film 76 having stripes 78 of black pigmented EVA and stripes 80 of the pressure sensitive adhesive. This film could, e.g. be laminated to a backing to provide a controlled adhesion film. FIG. 7c is a micrograph of a cross-section of the film 76 produced in Example 3.

### Example 4

This Example is similar to Example 3, except that the adhesive is delivered to the die in a 2:1 mass flow ratio. This resulted in a striped film 82 having stripes 84 of black pigmented EVA and stripes 86 of the pressure sensitive adhesive. FIG. 7d is a micrograph of a cross-section of the film 82 produced in Example 4.

This invention may take on various modifications and alterations without departing from its spirit and scope. Accordingly, this invention is not limited to the above-described embodiments but is to be controlled by the limitations set forth in the following claims and any equivalents thereof. This invention may be suitably practiced in the absence of any element not specifically disclosed herein. All patents and patent applications cited above, including those in the Background section, are hereby incorporated by reference into this document in their entirety.

1. A die for co-extruding a first extrudable polymeric material and a second extrudable polymeric material, the die comprising:
a first die cavity;
a second die cavity;
a septum separating at least a portion of said first die cavity and said second die cavity, said septum having a first side defining a portion of said first die cavity, a second side defining a portion of said second die cavity, a dispensing edge, and a plurality of first extrusion channels and a plurality of second extrusion channels, with said plurality of first extrusion channels connecting said first die cavity to said dispensing edge, said plurality of second extrusion channels connecting said second die cavity to said dispensing edge, and said plurality of first extrusion channels and said plurality of second extrusion channels being disposed in alternating positions along said dispensing edge such that one first channel is disposed between any two adjacent second channels, wherein each of said channels has an exit opening on said dispensing edge, and each said exit opening has a maximum width dimension of less than or equal to about 1.5 mm; and
a die opening through which an extrudate comprising the first and second extrudable polymeric materials is extruded.

2. (canceled)

3. The die according to claim 1, wherein each said exit opening has a minimum width dimension of about 50 micrometers.

4. The die according to claim 1, wherein each said channel is at least partially defined by opposite side walls with the side walls of at least said first channels being perpendicular or slanted at an angle to the first side of said septum.

5. The die according to claim 1, wherein each said channel is at least partially defined by opposite side walls and a joining surface, with the side walls of at least said first channels tapering out from their joining surface to the first side and the dispensing edge of said septum.

6. The die according to claim 1, wherein each said channel has an exit opening on said dispensing edge, and the exit openings of at least said first channels extend from the first side of said septum toward but not all the way to the second side of said septum.

7. A method of producing an extruded article, the method comprising:
providing a co-extrusion die according to claim 1;
supplying a first extrudable polymeric material into the first cavity;
supplying a second extrudable polymeric material into the second cavity;
extruding the first polymeric material through the plurality of first channels and the second polymeric material through the plurality of second channels so as to form a flow stream having a width with alternating zones of the first and second polymeric materials; and
extruding the flow stream through the die opening of the die so as to form an extrudate comprising a plurality of longitudinal first zones composed of the first polymeric material alternating with a plurality of longitudinal second zones composed of the second polymeric material such that one first zone is disposed between any two adjacent second zones.

8. An extruded article comprising a plurality of longitudinal first zones composed of a first polymeric material alternating with a plurality of longitudinal second zones composed of a second polymeric material such that one first zone is disposed between any two adjacent second zones, wherein the zones are generally parallel to one another, and at least one of each first zone and each second zone has a maximum width dimension of less than or equal to about 1.5 mm.

9. The extruded article according to claim 8, wherein the minimum width dimension of at least one of each first zone and each second zone is about 50 micrometers.

10. The extruded article according to claim 8, wherein each of the first zones is separate from one another, and the second zones are integrally joined together.

11. The extruded article according to claim 10, wherein the minimum width dimension of each first zone is about 50 micrometers.
